(19) United States
(12) Patent Application Publication
(10) Pub. No.: US 2005/0082275 A1
(43) Pub. Date: Apr. 21, 2005

(54) Methods for monitoring the danger of damage to a cooking surface or glass surface for cooking devices

(76) Inventors: Peter Nass, Mainz (DE); Kurt Schaupert, Hofheim (DE); Stefan Hubert, Engelstadt (DE); Harry Engelmann, Ingelheim (DE); Patrik Schober, Mainz (DE)

Correspondence Address: Pauley Petersen & Erickson, Suite 365, 2800 W. Higgins Road, Hoffman Estates, IL, 60195, US

(21) Appl. No.: 10/927,964

(22) Filed: Aug. 27, 2004

(30) Foreign Application Priority Data
Aug. 27, 2003 (DE) 103 39 411.7

(51) Int. Cl. H05B 3/68

(52) U.S. Cl. 219/446.1; 219/448.13

(57) ABSTRACT

A method for monitoring a danger of damage to a cooking surface for cooling devices, having at least one cooking zone which is heatable by an electrically operated heating device and is arranged on the cooking surface, wherein damage to the cooking surface is monitored on a basis of or as a function of heat effects. The thermally induced mechanical stresses in the cooking surface are directly detected. The method can also be used with viewing windows for an oven.

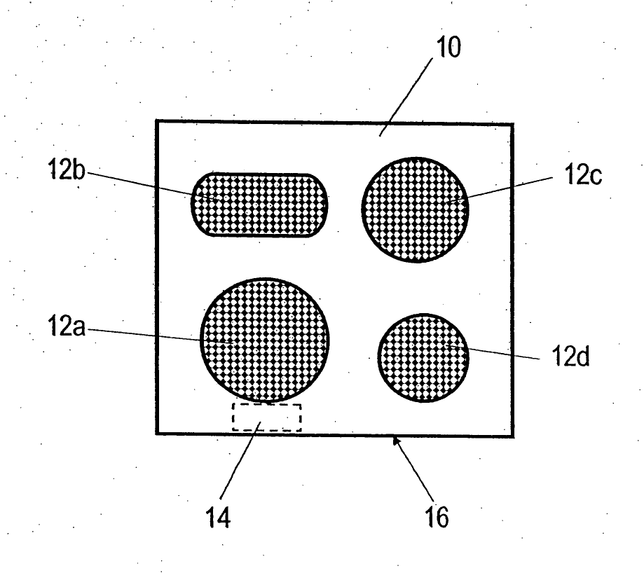

### BACKGROUND OF THE INVENTION

1. Field of the Invention

This invention relates to a method for monitoring the danger of damage to a cooking surface for cooking devices, having at least one cooking zone, which is heatable by an electrically operated heating device and is arranged on the cooking surface, wherein damage to the cooking surface is monitored on the basis of heat effects. This invention also relates to a method for monitoring the danger of damage to a glass surface of cooking devices, wherein the glass surface is heated by an electrically operated heating device and damage to the glass surface is monitored on the basis of heat effects.

2. Discussion of Related Art

Heating of cooking surfaces for cooking devices by radiant heating bodies, contact heating bodies or induction heating results in a thermal expansion in the heated area. This thermal expansion can lead to the tensile stress at portions of the cooking surface becoming so great that the cooking surface cracks.

The danger of damage caused by thermally induced mechanical stresses exists also in connection with a glass pane or glass surface, for example used as a viewing window for an oven.

It is known to use cooking surfaces made of glass-ceramic materials with very low thermal expansion. Such a glass-ceramic material is offered by SCHOTT GLAS under the tradename CERAN™. This CERAN™ glass-ceramic material cannot easily be colored in white or other shades of color for desired designs.

It is known from the prior art to monitor and limit the temperature in the hot zone when using a white or differently colored glass-ceramic material not having as low a thermal expansion as, for example the CERAN™ glass-ceramic material.

Such a temperature-monitoring method operates indirectly, because not the crack-causing stresses, but the temperature causing them is measured. Because the interconnection between the arising temperature, its local distribution and the stresses appearing in the glass-ceramic material are not easily known during the temperature-monitoring process, it is necessary to make sure that the glass-ceramic material used has a sufficiently low thermal expansion. Also, for preventing damage to the glass-ceramic material, the temperature occurring at the cooking surface must not be too high. The spatial arrangement of the cooking zones on the cooking surface, or their distance from each other, also affects the occurrence of damaging tensile stresses.

Thus, during a temperature-monitoring method it is necessary to include a defined safety margin regarding the above factors which cause a damaging tensile stress in the glass-ceramic material. Thus, the glass-ceramic material used cannot be heated to the maximum, not yet critical temperature, in order not to exceed the safety margin. Thus the actual possibilities of the cooking surface made of a glass-ceramic material cannot be used.

The entire cooking surface, or at least the critical areas of occurring tensile stresses at the cooking surface, can only be monitored to an insufficient extent with regard to the temperature distribution. No definite conclusions can be drawn regarding the associated tension conditions.

The safety margin which has to be maintained and the inexactness of the temperature measurement result in required use of glass-ceramic materials for induction cooking surfaces which have a lesser thermal expansion than is necessary and are therefore too expensive.

The problems discussed above as related to the example of a cooking surface for a cooking device correspondingly occur in connection with glass panes used as viewing windows for an oven, in particular in connection with grilling operations or pyrolysis.

### SUMMARY OF THE INVENTION

It is one object of this invention to disclose a method for monitoring the danger of damage to a cooking surface or to a glass surface for cooking devices which allows the use of materials with greater thermal expansion as compared to conventional materials. Such materials are more cost-effective than the conventional materials.

The above and other objects of this invention are achieved with a method for monitoring the danger of damage to a cooking surface and a method for monitoring the danger of damage to a glass surface as described in the claims and in this specification.

The thermally induced mechanical stresses in the cooking surface are directly detected. In connection with measuring accuracy and simplification of the measuring arrangement, it is advantageous in this process for the original value of the thermally induced mechanical damage, namely the stress itself, to be monitored instead of an indirect, non-representative values such as temperature, for example.

This method can be used in connection with a cooking surface wherein at least one cooking zone is radiantly heated, and wherein a white glass-ceramic material is used for the cooking surface. The use of such a material, which has a greater thermal expansion than, for example the CERAN™ glass-ceramic material, is possible with a monitoring method in accordance with this invention. Monitoring the thermally induced mechanical stresses makes it possible to stress the material thermally to a maximum degree.

Alternatively, the method can also be used in connection with a cooking surface, wherein the at least one cooking zone is heated by induction, and the material used for the cooking surface is a glass material.

To minimize the number of required measuring spots, and to obtain a dependable measuring result, the thermally induced stresses can be detected at known critical areas of the cooking surface or glass surface which are representative of the occurrence of thermally induced mechanical stresses.

In one advantageous manner it is possible to detect the thermally induced mechanical stresses in areas which are arranged outside of the hot areas of the cooking fields and which are calculated on the basis of a tension analysis by simulation calculations or other similar calculations. Thus the critical areas are often located between the heating device and the edge of the cooking surface, in particular in the center of this area. The thermally induced mechanical stresses are preferably there detected.

The thermally induced mechanical stresses can be detected in a particularly simple and yet dependable manner with at least one wire strain gauge. Alternatively, the thermally induced mechanical stresses can also be detected with an optical sensor arrangement for the direct detection of the occurring stress double refraction.

In connection with the dependable monitoring of thermally induced mechanical stresses, the method in accordance with this invention permits the use of materials for the cooking or glass surface which contain borofloat glass, soda-lime glass, or similar material, which can be made into flat glass.

In a particularly advantageous manner, the heating device can be switched off, at least temporarily, or its heat output can be reduced, if thermally induced mechanical stresses are detected which threaten to exceed the thermal expansion capability of the material used for the cooking or glass surface.

The method of this invention uses less expensive material with higher thermal expansion, along with improved monitoring of the occurring thermally induced stresses.

### BRIEF DESCRIPTION OF THE DRAWING

This invention is explained in greater detail in view of a preferred embodiment and by making reference to the attached drawing, wherein the drawing FIGURE shows a top perspective view of a cooking surface for a cooking device.

### DESCRIPTION OF PREFERRED EMBODIMENTS

A cooking surface 10 of a conventional cooking device in households and having four cooking zones 12a, 12b, 12c and 12d arranged on the cooking surface, each of which can be heated by an electrically operated heating arrangement, is represented in the drawing. The cooking zones 12a, 12c and 12d are round and have different diameters. The cooking zone 12b is elongated.

A possible damage of the cooking surface 10 because of the effects of heat from the four heating devices is monitored because the thermally induced mechanical stresses in the cooking surface are detected at critical points, or at locations representative thereof, so that heating of the heating devices can be shut off, if required. The area 14, which is located outside of the hot area of the cooking zone 12a, is shown in dashed lines in the drawing. The area 14 is determined by performed calculations, for example by tension analysis within the scope of a simulation calculation. In the typical cooking surface 10 shown, the area 14 is also the area of the greatest tension. The area 14 is located in the center of the zone between the cooking zone 12a and the edge 16 of the cooking surface 10. This applies correspondingly to the remaining cooking surfaces 12b, 12c and 12d.

The areas, not identified in detail, between the cooking zones 12a, 12b, 12c and 12d are critical areas for the appearance of considerable thermally induced stresses.

With the arrangement represented, the original value, namely the tension, is monitored, while an indirect, non-represented value, for example the temperature, is not used. Wire strain gauges or sensor arrangements, not represented, which operate in accordance with an optical method making use of the stress double refraction, for example, are considered for monitoring devices. The monitoring devices are arranged in the critical areas, preferably on the side of the cooking surface 10 facing away from the user. The area 14 is such an area, for example.

The monitoring devices, not represented, are connected with an electrical circuit, which processes the measured signals by an electronic evaluation device and forwards them, if required, to the temperature control circuit of the individual cooking zones. With this it is possible to match the temperature of the affected cooking zone as a function of the temperature and location to the detected tension status.

When monitoring the thermally induced stresses, this invention can be used with a radiation-heated or induction-heated cooking surface 10. A white, or different-colored glass-ceramic material or, for example, a borofloat glass or a flat glass containing soda-lime, can be used as the material for the cooking surface 10. Although these materials have a greater thermal expansion than the CERAN™ glass-ceramic material, the monitoring of the stress conditions also assures an interference-free operation of these materials.

This invention, for monitoring thermally induced stresses, can also be used in an oven viewing window, not represented, particularly during grilling operations or pyrolysis.

German Patent Reference 103 39 411.7, the priority document corresponding to this invention, and its teachings are incorporated, by reference, into this specification.

1. A method for monitoring a danger of damage to a cooking surface (10) for cooking devices, having at least one cooking zone (12a, 12b, 12c, 12d) heatable by an electrically operated heating device and arranged on the cooking surface (10), wherein a damage to the cooking surface (10) is monitored on a basis of heat effects, the method comprising:
directly detecting thermally induced mechanical stresses in the cooking surface (10).

2. The method in accordance with claim 1, wherein the at least one cooking zone (12a, 12b, 12c, 12d) is heatable by radiation and a material used for the cooking surface (10) contains a white glass-ceramic material.

3. The method in accordance with claim 2, wherein the at least one cooking zone (12a, 12b, 12c, 12d) is heatable by induction and the material used for the cooking surface (10) contains a glass material.

4. The method in accordance with claim 3, wherein the thermally induced mechanical stresses are detected in areas (14) outside of hot areas of the cooking zones (12a, 12b, 12c, 12d) and are calculated as a function of a tension analysis by one of simulation calculations and similar calculations.

5. The method in accordance with claim 4, wherein the thermally induced mechanical stresses are detected in the areas (14) between the heating device (12a) and an edge area (16) of the cooking surface (10).

6. The method in accordance with claim 5, wherein the thermally induced mechanical stresses are detectable by at least one wire strain gauge.

7. The method in accordance with claim 6, wherein the thermally induced mechanical stresses are detectable by an optical sensor arrangement for a direct detection of an occurring stress double refraction.

8. The method in accordance with claim 7, wherein the material used for one of the cooking surface and the glass surface contains a material containing one of a borofloat glass, a soda-lime glass, and a similar material, which can be made into flat glass.

9. The method in accordance with claim 8, wherein the heating device is one of switchable into an off condition at least temporarily and a heat output is reducible if the thermally induced mechanical stresses are detected which threaten to exceed a thermal expansion capability of the material used for one of the cooking surface and the glass surface (10).

10. The method in accordance with claim 1, wherein the at least one cooking zone (12a, 12b, 12c, 12d) is heatable by induction and a material used for the cooking surface (10) contains a glass material.

11. The method in accordance with claim 1, wherein the thermally induced mechanical stresses are detected in areas (14) outside of hot areas of the cooking zones (12a, 12b, 12c, 12d) ad are calculated as a function of a tension analysis by one of simulation calculations and similar calculations.

12. The method in accordance with claim 11 wherein the thermally induced mechanical stresses are detected in the areas (14) between the heating device (12a) and an edge area (16) of the cooking surface (10).

13. The method in accordance with claim 1, wherein the thermally induced mechanical stresses are detectable by at least one wire strain gauge.

14. The method in accordance with claim 1, wherein the thermally induced mechanical stresses are detectable by an optical sensor arrangement for a direct detection of an occurring stress double refraction.

15. The method in accordance with claim 1, wherein a material used for one of the cooking surface and the glass surface contains a material containing one of a borofloat glass, a soda-lime glass, and a similar material, which can be made into flat glass.

16. The method in accordance with claim 1, wherein the heating device is one of switchable into an off condition at least temporarily and a heat output is reducible if the thermally induced mechanical stresses are detected which threaten to exceed a thermal expansion capability of a material used for one of the cooking surface and the glass surface (10).

17. A method for monitoring a danger of damage to a glass surface of cooking devices, wherein the glass surface is heated by an electrically operated heating device and damage to the glass surface is monitored on a basis of heat effects, the method comprising:
directly detecting thermally induced mechanical stresses in the glass surface (10).

18. The method in accordance with claim 4, wherein the thermally induced mechanical stresses are detected at known critical areas (14) of one of a cooking surface and the glass surface which is representative of an occurrence of the thermally induced mechanical stresses.
